(19) United States
(12) Patent Application Publication
(10) Pub. No.: US 2013/0235972 A1
(43) Pub. Date: Sep. 12, 2013

(54) METHOD FOR MANUFACTURING COLLIMATOR, COLLIMATOR AND X-RAY CT APPARATUS

(71) Applicants: Nobuyoshi Kuroiwa, Kanagawa-ken (JP); Hideshi Nakano, Kanagawa-ken (JP); Shuya Nambu, Tochigi-ken (JP); Yoshiaki Yaoi, Tochigi-ken (JP)

(72) Inventors: Nobuyoshi Kuroiwa, Kanagawa-ken (JP); Hideshi Nakano, Kanagawa-ken (JP); Shuya Nambu, Tochigi-ken (JP); Yoshiaki Yaoi, Tochigi-ken (JP)

(73) Assignees: Toshiba Medical Systems Corporation, Otawara-shi (JP); Kabushiki Kaisha Toshiba, Tokyo (JP)

(21) Appl. No.: 13/427,312

(22) Filed: Mar. 22, 2012

(30) Foreign Application Priority Data
Mar. 8, 2012 (JP) 2012-052341

(51) Int. Cl. G21K 1/02; B32B 37/14; B32B 37/12; G01N 23/083

(52) U.S. Cl. 378/19; 378/149; 156/293

(57) ABSTRACT

According to one embodiment, a method is disclosed for manufacturing a collimator. The method can include forming a first plate-like part having a plurality of first slits. The method can include forming a second plate-like part having a plurality of second slits. The method can include causing the first slits and the second slits to face each other and assembling a plurality of the first plate-like parts and a plurality of the second plate-like parts so as to intersect each other. Portions of the second plate-like parts where the second slits are not provided are held on an opening side of the first slits. The second plate-like parts are inclined so as to follow an inclination of the first slits. The inclined second plate-like parts are moved toward a bottom of the first slits.

### CROSS-REFERENCE TO RELATED APPLICATIONS

This application is based upon and claims the benefit of priority from the prior Japanese Patent Application No.2012-052341, filed on Mar. 8, 2012; the entire contents of which are incorporated herein by reference.

### FIELD

Embodiments described herein relate generally to a method for manufacturing a collimator, a collimator, and an X-ray CT apparatus.

### BACKGROUND

In an X-ray CT (Computer Tomography) apparatus, in order to increase the number of detection points to increase spatial resolution, an X-ray detector using a scintillator has been used.

Upon request to take a photograph of a wide range at high speed and high definition, the X-ray detector including a plurality of photoelectric conversion elements both in a channel direction and a slice direction has been used. In such X-ray detector, when the number of the photoelectric conversion elements in the slice direction increases, it is needed to remove scattered X-rays in the channel direction as well as the slice direction.

For this reason, there is proposed a collimator formed by stacking a plurality of elements in which a flat plate-like bottom part and a plurality of wall parts protruding from the bottom part are integrally molded.

However, when the bottom part and the wall parts are integrally molded, a corner of each of intersections of the bottom part and the wall parts is rounded, thereby lowering aperture ratio.

In this case, the geometric efficiency of the X-ray detector is a ratio of an effective area of a detecting part to a total area of the X-ray detector. Thus, when the aperture ratio lowers, the geometric efficiency also lowers.

### BRIEF DESCRIPTION OF THE DRAWINGS

FIG. 1 is a schematic block diagram for illustrating schematic configuration of the X-ray CT apparatus.

FIG. 2 is a schematic perspective view illustrating the radiation detector.

FIG. 3 is a schematic sectional view showing an A-A cross section in FIG. 2.

FIGS. 4A and 4B are schematic perspective views illustrating the collimator.

FIGS. 5A and 5B are schematic views illustrating the plate-like parts constituting the collimator.

FIG. 6 is a schematic perspective view illustrating the section.

FIGS. 7A and 7B are schematic perspective views illustrating the lattice structure part of modular unit.

### DETAILED DESCRIPTION

In general, according to one embodiment, a method is disclosed for manufacturing a collimator. The method can include forming a first plate-like part having a plurality of first slits inclined at a predetermined angle corresponding to a focal position of a radiation source. The method can include forming a second plate-like part having a plurality of second slits inclined at a predetermined angle corresponding to the focal position. The method can include causing the first slits and the second slits to face each other and assembling a plurality of the first plate-like parts and a plurality of the second plate-like parts so as to intersect each other.

The causing the first slits and the second slits to face each other and assembling a plurality of the first plate-like parts and a plurality of the second plate-like parts so as to intersect each other includes the followings. Portions of the second plate-like parts where the second slits are not provided are held on an opening side of the first slits. The second plate-like parts are inclined so as to follow an inclination of the first slits. The inclined second plate-like parts are moved toward a bottom of the first slits.

Embodiments of the invention will now be described below with reference to the drawings. The same constituents are given the same numerals throughout the figures and detailed description thereof is omitted as appropriate.

In following description, although a case where a radiation is an X-ray is used as an example, the invention can be also applied to other radiation such as a γ-ray.

Thus, for example, when an exemplified X-ray detector is applied to other radiation, “X-ray” may be replaced with “other radiation (for example, γ-ray)”.

### First Embodiment

First, a collimator 1 and an X-ray CT apparatus 100 in accordance with the embodiment will be described.

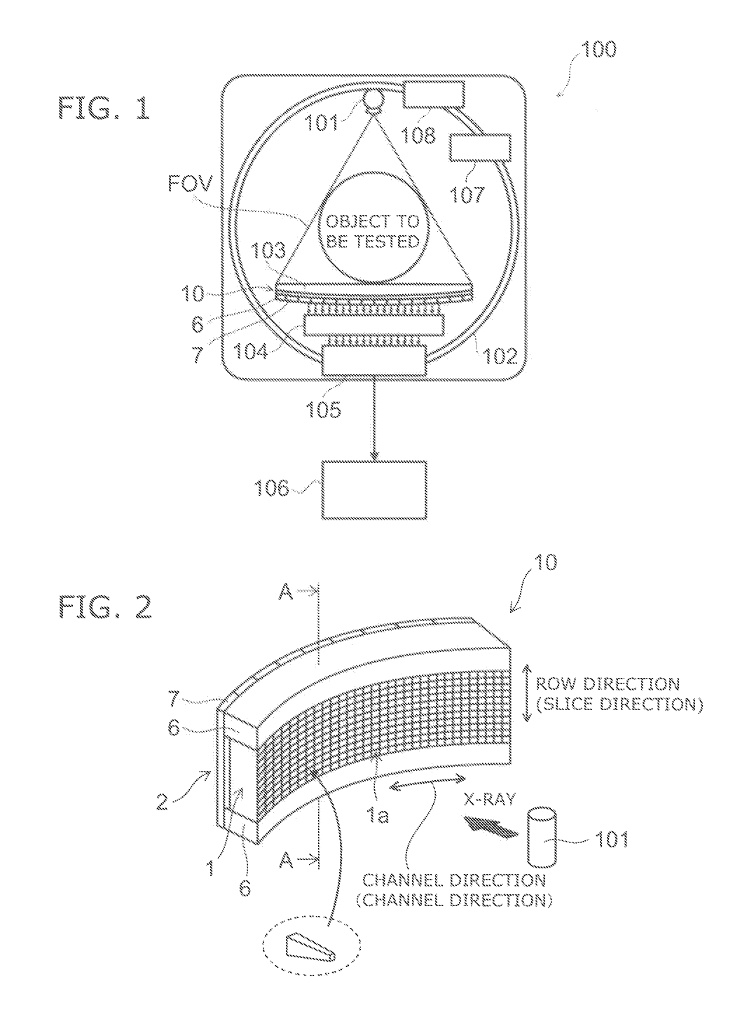

FIG. 1 is a schematic block diagram for illustrating schematic configuration of the X-ray CT apparatus.

As shown in FIG. 1, the X-ray CT apparatus 100 includes an X-ray tube 101, a rotational ring 102, a two-dimensional detecting part 103, a data acquisition circuit (DAS) 104, a non-contact data transmission device 105, a platform driving part 107, a slip ring 108 and a processing part 106.

The X-ray tube 101 as an X-ray source emitting an X-ray is a vacuum tube generating the X-ray and is supported by the rotational ring 102. Electric power (tube current, tube voltage) necessary for exposure of the X-ray is supplied from an unillustrated high-voltage generator to the X-ray tube 101 via the slip ring 108. The X-ray tube 101 causes an electron accelerated by a supplied high voltage to hit a target, thereby exposing the X-ray toward an object to be tested in an effective field of view FOV.

An X-ray tube-side collimator not shown for shaping the shape of an X-ray beam exposed from the X-ray tube 101 into a cone shape, quadrangular pyramid shape or fan beam shape is provided between the X-ray tube 101 and the object to be tested.

The two-dimensional detecting part 103 is a detector system for detecting the X-ray passing through the object to be tested and is supported by the rotational ring 102 so as to face the X-ray tube 101. A radiation detector 10 is attached to an outer circumferential side of the two-dimensional detecting part 103 (opposite side of the object to be tested). That is, the radiation detector 10 including the collimator 1 described later, a scintillator 4 for receiving the X-ray to emit fluorescence and a photoelectric converting part 12 for converting the fluorescence into an electric signal is attached to the outer circumferential side of the two-dimensional detecting part 103.

Details of the collimator 1 and so on will be described later.

The X-ray tube 101 and the two-dimensional detecting part 103 are supported by the rotational ring 102. The rotational ring 102 is driven by the platform driving part 107 and rotates about the object to be tested.

The data acquisition circuit (DAS) 104 has a plurality of data acquisition element rows in which DAS chips are arranged, and receives an input of data detected by the two-dimensional detecting part 103 (hereinafter referred to as raw data). Then, the input raw data is amplified and A/D converted and then, transmitted to the processing part 106 via a data transmitter 105.

The platform driving part 107 performs driving and its control, for example, integrally rotates the X-ray tube 101 and the two-dimensional detecting part 103 about a central axis that is parallel to a body-axis direction of the object to be tested inserted into a diagnostic opening.

The processing part 106 creates “projection data” by performing correction of the sensitivity of the raw data and correction of the intensity of the X-ray. Then, reconstructed image data of predetermined slices is created by reconstructing the projection data on the basis of predetermined reconstruction parameters (reconstruction region size, reconstruction matrix size, threshold value for extracting concerned region and so on). The reconstructed image data is subjected to image processing for display, such as window conversion and RGB processing, and is outputted as an image to a display device not shown.

That is, the processing part 106 reconstructs a tomographic image of the object to be tested on the basis of the intensity of the X-ray detected by the radiation detector 10.

FIG. 2 is a schematic perspective view illustrating the radiation detector.

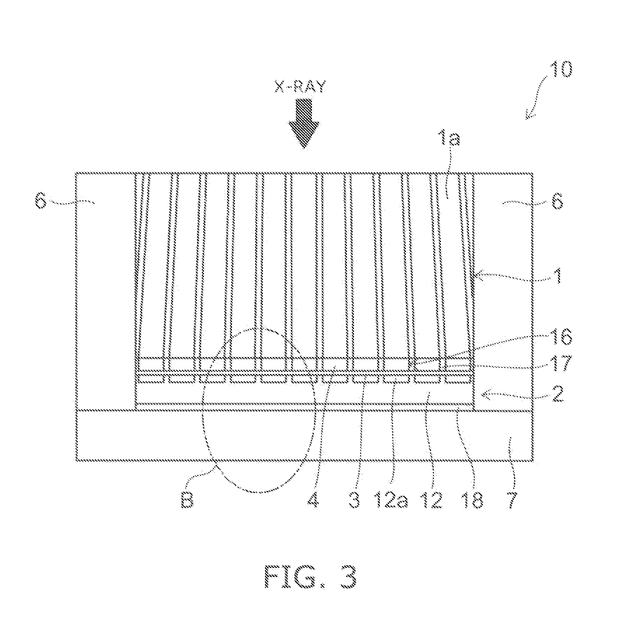

FIG. 3 is a schematic sectional view showing an A-A cross section in FIG. 2.

As shown in FIG. 2, the radiation detector 10 includes a detecting part 2 and the collimator 1. A holding part 6 is a member provided at the two-dimensional detecting part 103 for holding the radiation detector 10.

As shown in FIG. 2, the collimator 1 has a lattice structure formed of an X-ray shielding plate (plate-like parts 11, 21 described later) for shielding the X-ray, and each section of the lattice structure corresponds to each section of the scintillator 4. In this case, when the collimator 1 is provided at a predetermined position in the X-ray CT apparatus 100 shown in FIG. 1, each section of the lattice structure of the collimator 1 faces the focus of the X-ray tube 101 (X-ray source). For example, as shown in FIG. 2, each rectangular section can be configured so as to be shaped like a quadrangular pyramid in a plan view. Such lattice structure can be formed by inclining each X-ray shielding plate constituting each section at a predetermined angle in both the channel direction and the slice direction of the collimator 1 so as to face the focus of the X-ray tube 101 when the collimator 1 is provided at the predetermined position in the X-ray CT apparatus 100 shown in FIG. 1. Details of the collimator 1 will be described later.

As shown in FIG. 3, the detecting part 2 is provided with the scintillator 4, a light reflecting part 17, an adhesive layer 3, the photoelectric converting part 12, a circuit board 18 and a bottom part 7.

The scintillator 4 is divided into sections corresponding to detection sections of the photoelectric conversion elements 12a provided in the photoelectric converting part 12, and a groove 16 is formed between the respective detection sections. That is, each scintillator 4 is divided by the groove 16. The scintillator 4 is bonded to the photoelectric converting part 12 so that their sections correspond to each other.

The scintillator 4 is provided facing the collimator 1, receives radiation such as the X-ray and emits the fluorescence. The fluorescence is, for example, light such as a visible light ray. Since maximum luminous wavelength, attenuation time, reflection coefficient, density, light output ratio and temperature dependency on the fluorescence efficiency of the scintillator 4 vary depending on the material for the scintillator 4, the material can be selected according to usage. For example, a ceramic scintillator formed of a sintered body of rare-earth oxysulfide is used for the X-ray CT apparatus. However, the material is not limited to this, and may be appropriately changed.

The light reflecting part 17 formed by inserting and bonding a body having a function of reflecting light of wavelength in the vicinity of luminous wavelength of the scintillator 4 (for example, a while plate-like body) is provided in the groove 16 between the scintillators 4.

The light reflecting part 17 that sections the scintillator 4 for each photoelectric conversion element 12a serves to perform optical separation between the sections of each scintillator 4 and reflection, thereby suppressing optical crosstalk between the respective sections.

The photoelectric converting part 12 has the photoelectric conversion elements 12a for converting the fluorescence from the scintillator 4 into an electric signal. The photoelectric conversion elements 12a are, for example, silicon photo diodes with pin structure.

The adhesive layer 3 is made of, for example, a transparent adhesive, and bonds the scintillator 4 to the photoelectric converting part 12 while improving transmission of light between them.

The circuit board 18 is provided on the face opposite to the face on the side of the photoelectric converting part 12 to be bonded to the scintillator 4. The circuit board 18 is also sectioned so as to correspond to the sections of the scintillator 4 and is configured to allow take-in of the electric signal of each section.

The bottom part 7 is shaped like a flat plate, and on a main surface thereof, the circuit board 18, the photoelectric converting part 12, the adhesive layer 3 and the scintillator 4 provided with the light reflecting part 17 are provided in a stacked manner. The bottom part 7 can be attached to the holding part 6 by use of a fastening means such as a screw not shown. By attaching the bottom part 7 to the holding part 6, the scintillator 4 and the like provided in a stacked manner are held by the holding part 6.

The holding part 6 provided in the two-dimensional detecting part 103 to hold the radiation detector 10 can be shaped like a circular arc so that each scintillator 4 faces the focus of the X-ray source (X-ray tube 101). The pair of holding parts 6 is spaced at a predetermined interval so as to face each other, and holds the collimator 1 therebetween. In this case, for example, by bonding the collimator 1 between the holding parts 6 by use of an adhesive, the collimator 1 can be held by the holding parts 6. However, the holding method of the collimator 1 is not limited to bonding using the adhesive and may be appropriately changed. For example, by fitting the collimator 1 into a groove not shown provided in the holding part 6, the collimator 1 can be held by the holding parts 6.

The bottom part 7 provided at the detecting part 2 is held on an outer circumferential side (convex side of the circular arc) of the pair of holding parts 6. A plurality of bottom parts 7 are provided along the circumferential faces of the holding parts 6 so as to conform to the outer circumferential shape of the holding parts 6.

Next, the collimator 1 will be further described.

As shown in FIG. 2, the collimator 1 has the lattice structure on the cross section intersecting the passage direction of the X-ray emitted from the X-ray tube 101. The rectangular sections are formed in the lattice structure so that the area of the cross section of the structure becomes larger as the distance thereof increases from the X-ray tube 101. Here, the lattice structure can be provided in a configuration, for example as shown in FIG. 2, so that each rectangular section is shaped like a quadrangular pyramid. As shown in FIG. 3, the collimator 1 controls the X-ray incident to each scintillator 4, and absorbs the scattered X-rays to reduce crosstalk due to the scattered X-rays.

Examples of the material for the collimator 1 include W (tungsten), Mo (molybdenum), Ta (tantalum), Pb (lead) and an alloy containing at least one of these heavy metals. However, the material is not limited to these and a material having an excellent X-ray shielding characteristic can be appropriately selected.

As described later, the lattice structure of the collimator 1 can be also configured by preparing a plurality of lattice structures of modular units (or referred to as block units) and combining the lattice structures of modular units. In this case, the lattice structures of modular units are attached in line with the holding parts 6 (support members) while positioning the lattice structures so that each section faces the focus of the X-ray tube 101 (X-ray source).

The lattice structures of modular units may be detachable with respect to the holding parts 6.

Here, the collimator may be integrally molded by using a member obtained by bending a thin plate so that the rectangular sections are formed on the above-mentioned cross section (that is, the cross section intersecting the passage direction of the X-ray), or sections having rectangular cross section are formed by stacking the plurality of integrally molded elements. However, in doing so, any of four corners of the rectangular cross section is rounded and thus, the lattice shape becomes non-uniform, resulting in a decrease in the aperture ratio.

In such case, in terms of an image taken from the object to be tested, since the geometric efficiency of the radiation detector 10 is a ratio of the effective area of the detecting part 2 to the total area of the radiation detector 10, when the aperture ratio decreases, the geometric efficiency also decreases. In the case where the collimator with the decreased geometric efficiency is used, in the X-ray CT apparatus, the quality of the taken image of the object to be tested deteriorates.

In recent years, to increase the resolution of the X-ray CT apparatus, higher definition of acquired data such as an image has been achieved through multi-row detectors including collimators and therefore, the size of the section tends to be small. For this reason, when any of four corners of the rectangular cross section of the section is rounded, the effect can be great.

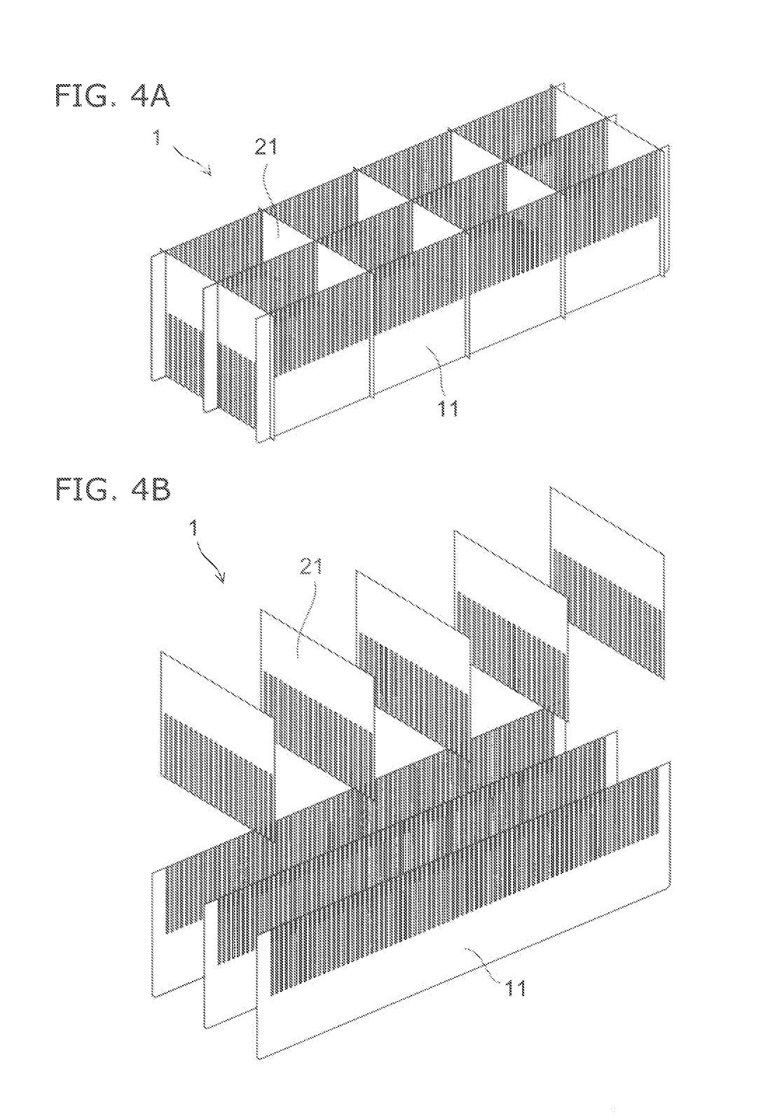

FIGS. 4A and 4B are schematic perspective views illustrating the collimator.

FIG. 4A is a schematic perspective view illustrating outer appearance of the collimator, and FIG. 4B is a schematic exploded view of the collimator.

To avoid complexity, the plate-like parts are thinned out.

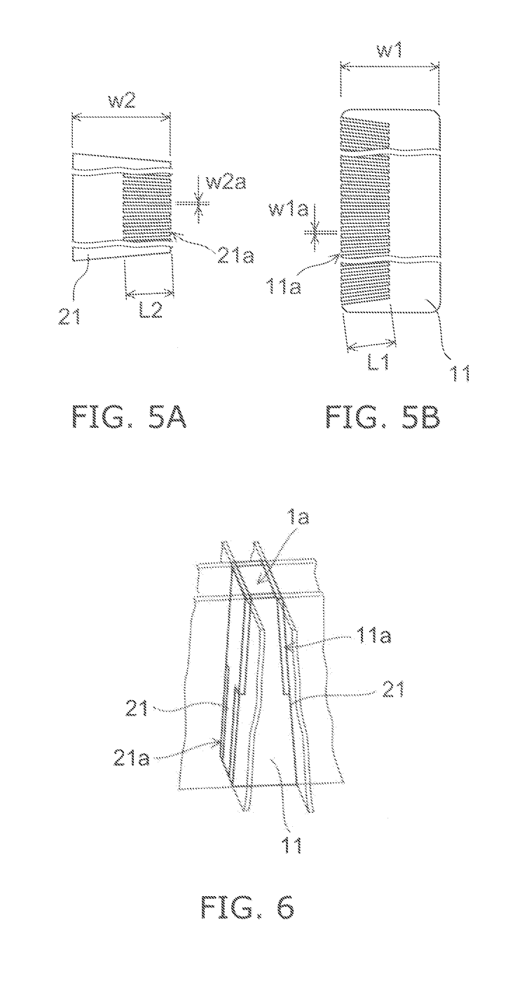

FIGS. 5A and 5B are schematic views illustrating the plate-like parts constituting the collimator.

As shown in FIGS. 4A and 4B, FIGS. 5A and 5B, the collimator 1 includes the plurality of plate-like parts 11 arranged spaced apart from each other (corresponding to an example of first plate-like part) and the plurality of plate-like parts 21 arranged spaced apart from each other in a direction intersecting the plate-like parts 11 (corresponding to an example of second plate-like part).

A plurality of slits 11a (corresponding to an example of first slits) are formed spaced apart from each other in the plate-like part 11. The number of the slits 11a can be set to the number of the fitted plate-like parts 21. A width W1 of the plate-like part 11 can be made equal to a width W2 of the plate-like part 21.

The width W1a of the slit 11a is slightly larger than a thickness of the plate-like part 21. A length L1 of the slits 11a can be set to, for example, about a half of the width W1 of the plate-like part 11.

The slits 11a are formed to be inclined at a predetermined angle corresponding to the focal position of the X-ray source (X-ray tube 101). For this reason, by fitting the plate-like parts 21 into the slits 11a, the plate-like parts 21 can be inclined at the predetermined angle corresponding to the focal position of the X-ray source.

A plurality of slits 21a (corresponding to an example of second slits) are formed spaced apart from each other in the plate-like part 21. The number of slits 21a can be set to the number of the fitted plate-like parts 11.

The width W2a of the slits 21a is slightly larger than a thickness of the plate-like part 11. A length L2 of the slits 21a is set to, for example, about a half of the width W2 of the plate-like part 21.

The slits 21a are formed to be inclined at a predetermined angle corresponding to the focal position of the X-ray source. For this reason, by fitting the plate-like parts 11 into the slits 21a, the plate-like part 11 can be inclined at the predetermined angle corresponding to the focal position of the X-ray source.

In this case, at a position where the plate-like parts 11 intersect the plate-like parts 21, the slits 11a and the slits 21a face each other.

That is, portions of the plate-like parts 21 where the slits 21a are not provided are fitted into the slits 11a, and portions of the plate-like parts 11 where the slits 11a are not provided are fitted into the slits 21a, resulting in that the plate-like parts 11 intersect the plate-like parts 21.

When the plate-like parts 11 and the plate-like parts 21 are assembled to each other to form the collimator 1, as shown in FIG. 4B, the slits 1a of the plate-like parts 11 are caused to face the slits 21a of the plate-like parts 21 and the portions of the plate-like parts 21 where the slits 21a are not provided are fitted into the slits 11a. At this time, the portions of the plate-like parts 11 where the slits 11a are not provided are fitted into the slits 21a.

FIG. 6 is a schematic perspective view illustrating the section.

As described above, by assembling the plate-like parts 11 and the plate-like parts 21 to each other, the plate-like parts 11 and the plate-like parts 21 are inclined at the predetermined angle corresponding to the focal position of the X-ray source.

For this reason, an outer shape of a section la formed by being defined by the plate-like parts 11 and the plate-like parts 21 is a quadrangular pyramid as shown in FIG. 6.

In this case, since the section 1a is formed by fitting the plate-like slits to the corresponding plate-like parts, the four corners of the rectangular cross section of the section 1a are hardly rounded. For this reason, the decrease in the aperture ratio can be prevented, thereby improving the geometric efficiency. Accordingly, in the detector including the collimator, multi-row in the channel direction and the slice direction can be addressed. By using such collimator with improved geometric efficiency, in the X-ray CT apparatus, the spatial resolution and an image quality of the taken image of the object to be tested are improved, enabling acquisition of high-definition data.

It should be noted that the plate-like part 11 and the plate-like part 21 are not necessarily fixed to each other.

However, by fixing the plate-like parts 11 and the plate-like parts 21 to each other, the effect such as vibration is hard to occur.

In this case, the plate-like parts 11 and the plate-like parts 21 can be fixed to each other by use of an adhesive. Details of fixation using the adhesive will be described later.

### Second Embodiment

Next, a method for manufacturing the collimator in accordance with the embodiment will be described.

First, the plate-like part 11 and the plate-like part 21 are formed.

That is, the plate-like part 11 having the plurality of slits 11a inclined at a predetermined angle corresponding to the focal position of the X-ray source is formed. The plate-like part 21 having the plurality of slits 21a inclined at a predetermined angle corresponding to the focal position of the X-ray source is formed.

Blanks of the plate-like part 11 and the plate-like part 21 are cut out from a flat plate material using a material excellent in X-ray shielding characteristic.

Then, the slits 11a having predetermined shape and dimension are formed in the blank of the plate-like part 11 and the slits 21a having predetermined shape and dimension are formed in the blank of the plate-like part 21.

The lattice structure formed of the plate-like parts 11, 21 is formed in the collimator. Here, when the lattice structure is provided at a predetermined position in the X-ray CT apparatus, the sections of the lattice structure needs to be configured so as to face the focus of the X-ray tube 101 (X-ray source).

Accordingly, the slits 11a of the plate-like part 11 and the slits 21a of the plate-like part 21 need to have the predetermined shape and dimension so as to achieve the collimator with such configuration.

In this case, examples of a material excellent in X-ray shielding characteristic include W (tungsten), Mo (molybdenum), Ta (tantalum), Pb (lead) and an alloy containing at least one of these heavy metals. However, the material is not limited to these and the material excellent in X-ray shielding characteristic can be appropriately selected.

The slits 11a and the slits 21a can be formed, for example, by etching.

Next, the plate-like part 11 and the plate-like part 21 are assembled so as to intersect each other.

Here, the collimator 1 can be manufactured by sequentially assembling the plate-like part 11 or the plate-like part 21 one by one.

Such lattice structure can be formed by inclining each X-ray shielding plate constituting each section in two directions: the channel direction and the slice direction of the collimator 1 at a predetermined angle so as to face the focus of the X-ray tube 101 when the collimator 1 is provided at the predetermined position in the X-ray CT apparatus 100 shown in FIG. 1.

The lattice structure of the collimator 1 can be also configured by preparing a plurality of lattice structure parts of modular units and combining these lattice structure parts of modular units.

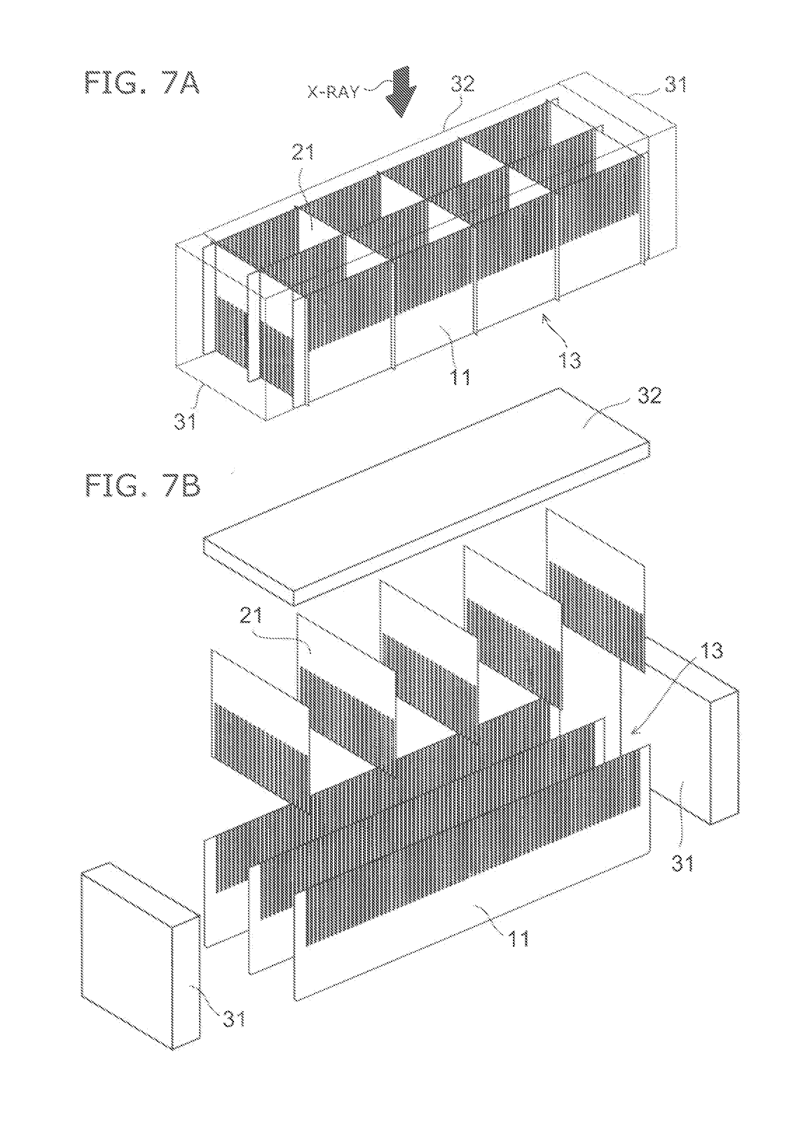

FIGS. 7A and 7B are schematic perspective views illustrating the lattice structure part of modular unit.

FIG. 7A is a schematic perspective view illustrating an outer appearance of the lattice structure part of modular unit, and FIG. 7B is a schematic exploded view of the lattice structure part of modular unit.

To avoid complexity, the plate-like parts are thinned out.

As shown in FIGS. 7A and 7B, the plate-like parts 11, the plate-like parts 21, connecting parts 31 and a covering part 32 are provided in the lattice structure part 13.

The connecting part 31 is made of a material having a high rigidity, such as metal, and can be bonded to the ends of the plate-like parts 11 by use of an adhesive or the like.

The covering part 32 is shaped like a flat plate and covers an incident face of the X-ray.

The covering part 32 may have grooves not shown for fitting the ends of the plate-like parts 11 and the plate-like parts 21.

The covering part 32 is made of a material having a high transmittance of the X-ray and a high rigidity. The covering part 32 can be made of, for example, carbon fiber reinforced plastics (CFRP).

The covering part 32 can be bonded to the plate-like parts 11 and the plate-like parts 21 by use of an adhesive or the like. Further, the covering part 32 can be also bonded to the connecting parts 31 by use of an adhesive or the like.

In this case, the collimator 1 is configured by attaching the lattice structure part 13 of modular units in line with the bow-like holding parts 6 via the connecting parts 31 while positioning the lattice structure part 13 so that each section thereof faces the focus of the X-ray tube 101 (X-ray source). Here, the bow-like holding parts 6 are formed so that each point thereof draws a circular arc with a predetermined curvature so as to face the focus of the X-ray tube 101 (X-ray source) when the collimator 1 is provided at the predetermined position in the X-ray CT apparatus 100 shown in FIG. 1.

The lattice structure part 13 of modular units may be detachable with respect to the holding parts 6.

According to the above-exemplified embodiments, the manufacturing method of collimator, the collimator and the X-ray CT apparatus that can improve the geometric efficiency can be realized.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

For example, shape, size, material, arrangement and the number of each constituent included in the collimator 1 and the X-ray CT apparatus 100 are not limited to those exemplified and may be appropriately changed.

What is claimed is:

1. A method for manufacturing a collimator comprising:
forming a first plate-like part having a plurality of first slits inclined at a predetermined angle corresponding to a focal position of a radiation source;
forming a second plate-like part having a plurality of second slits inclined at a predetermined angle corresponding to the focal position; and
causing the first slits and the second slits to face each other and assembling a plurality of the first plate-like parts and a plurality of the second plate-like parts so as to intersect each other, wherein:
in the causing the first slits and the second slits to face each other and assembling a plurality of the first plate-like parts and a plurality of the second plate-like parts so as to intersect each other;
portions of the second plate-like parts where the second slits are not provided are held on an opening side of the first slits;
the second plate-like parts are inclined so as to follow an inclination of the first slits; and
the inclined second plate-like parts are moved toward a bottom of the first slits.

2. The method according to claim 1, further comprising fixing the assembled plurality of first plate-like parts and plurality of second plate-like parts to each other by use of an adhesive.

3. The method according to claim 1, further comprising providing a covering part for covering ends of the plurality of the first plate-like parts on the side of the radiation source and ends of the plurality of the second plate-like parts on the side of the radiation source.

4. The method according to claim 1, further comprising bonding a connecting part to ends provided in a direction intersecting ends of the plurality of the first plate-like parts on the side of the radiation source.

5. A collimator comprising:
a plurality of first plate-like parts each having a plurality of first slits inclined at a predetermined angle corresponding to a focal position of a radiation source; and
a plurality of second plate-like parts provided intersecting the plurality of first plate-like parts, each of the plurality of second plate-like parts having a plurality of second slits inclined at a predetermined angle corresponding to the focal position, wherein:
portions of the second plate-like parts where the second slits are not provided are fitted into the first slits; and
portions of the first plate-like parts where the first slits are not provided are fitted into the second slits.

6. The collimator according to claim 5, wherein the plurality of first plate-like parts and the plurality of second plate-like parts are provided in a grid pattern.

7. The collimator according to claim 5, wherein a section defined by the plurality of first plate-like parts and the plurality of second plate-like parts has an outer shape of a quadrangular pyramid.

8. The collimator according to claim 5, wherein a sectional area of a section defined by the plurality of first plate-like parts and the plurality of second plate-like parts becomes larger as a distance of the section increases from the focal position.

9. The collimator according to claim 5, wherein the first slits face the second slits at positions where the plurality of first plate-like parts intersect the plurality of second plate-like parts.

10. The collimator according to claim 5, wherein the plurality of first plate-like parts are bonded to the plurality of second plate-like parts via an adhesive layer.

11. The collimator according to claim 5, further comprising a covering part for covering ends of the plurality of first plate-like parts on the side of the radiation source and ends of the plurality of second plate-like parts on the side of the radiation source.

12. The collimator according to claim 5, further comprising a connecting part bonded to ends provided in a direction intersecting ends of the plurality of first plate-like parts on the side of the radiation source.

13. The collimator according to claim 11, wherein the covering part allows radiation to pass through.

14. An X-ray CT apparatus comprising:
an X-ray source for emitting an X-ray as radiation;
a radiation detector including a collimator according to claim 5, a scintillator for receiving the X-ray to emit fluorescence and a photoelectric converting part for converting the fluorescence into an electric signal;
a rotational ring that supports the X-ray source and the radiation detector and rotates around an object to be tested; and
a processing part for reconfiguring a tomographic image of the object to be tested on the basis of the intensity of the X-ray detected by the radiation detector.
